(19) United States
(12) Patent Application Publication
(10) Pub. No.: US 2025/0190286 A1
(43) Pub. Date: Jun. 12, 2025

(54) EVENT PROCESSING IN AN EVENT-DRIVEN ARCHITECTURE

(71) Applicant: INTERNATIONAL BUSINESS MACHINES CORPORATION, Armonk, NY (US)

(72) Inventors: Tanmay Arvind Ambre, Pune (IN); Amit Deshpande, Pune (IN); Harish Bharti, Pune (IN); Rajesh Kumar Saxena, Thane West (IN); Balakrishnan Sreenivasan, Bangalore (IN)

(21) Appl. No.: 18/530,563

(22) Filed: Dec. 6, 2023

(51) Int. Cl. G06F 9/54

(52) U.S. Cl. CPC G06F 9/542

(57) ABSTRACT

A method, computer program product, and computer system for processing events in an event-driven architecture. A dynamic scan of log data generated from multiple executions of a software program that executes events is performed. The dynamic scan identifies events that occurred and event triggers that invoked the identified events or invoked other event triggers. An event hierarchy that includes event nodes and events edges connects event nodes is generated by organizing the identified events and event triggers into the event hierarchy. Each event node satisfying criteria involving a frequency of occurrence of the events directly or indirectly invoked by each event node is tagged. An event message having a header portion that includes an identification of all tagged event nodes and a body portion that includes event attributes. The header portion, but not the body portion, of the event message is sent to event subscribers.

### BACKGROUND

The present invention relates to an event-driven architecture, and more specifically, to processing events in the event-driven architecture.

### SUMMARY

Embodiments of the present invention provide a method, a computer program product, and a computer system for processing events in an event-driven architecture. One or more processors of a computer system perform a dynamic scan of log data generated from multiple executions of a software program that executes events. The dynamic scan identifies a plurality of events that occurred and identifies event triggers that invoked the identified events or invoked other event triggers. The one or more processors generate an event hierarchy by organizing the identified events and identified event triggers into the event hierarchy of N levels denoted as levels 1, . . . , N wherein N is at least 2. The event hierarchy comprises event nodes and event edges. Each event edge connects two event nodes disposed at successive levels of the N levels. The event nodes of level N are leaf nodes. Each leaf node comprises program code whose execution performs one event of the identified events. The event nodes of levels 1, . . . , N−1 are trigger nodes encompass the identified event triggers and respectively trigger event nodes 2, . . . , N. The one or more processors tag each event node satisfying criteria involving a frequency of occurrence of the events directly or indirectly invoked by each event node. The one or more processors generate an event message having a header portion and a body portion. The body portion comprises attributes of the plurality of events. The header portion comprises an identification of all tagged event nodes. The one or more processors send the header portion, but not the body portion, of the event message to all event subscribers who are subscribed to at least one event of the plurality of events.

### BRIEF DESCRIPTION OF THE DRAWINGS

FIG. 1 is a conventional event-driven architecture, in accordance with the prior art.

FIG. 2 is an event-driven architecture, in accordance with embodiments of the present invention.

FIG. 3 depicts a data store that is within the event-driven architecture of FIG. 2, in accordance with embodiments of the present invention.

FIG. 4 is a flow chart of a method for processing events in an event-driven architecture, in accordance with embodiments of the present invention.

FIG. 5A-5D illustrate steps of the method of FIG. 4, in accordance with second embodiments of the present invention.

FIG. 6A-6D illustrate steps of the method of FIG. 4, in accordance with second embodiments of the present invention.

FIG. 6E depicts changing event node tags in an event hierarchy in FIG. 6D, in accordance with embodiments of the present invention.

FIG. 6F depicts adding parameter nodes to a parameter hierarchy and corresponding event nodes to an event hierarchy of FIG. 6A, in accordance with embodiments of the present invention.

FIG. 7 is a flow chart of a method for processing events in an event-driven architecture based in part on a dynamic scan of log data, in accordance with embodiments of the present invention.

FIG. 8 is a flow chart of processes that enhance the method of FIG. 7 based in part on a static scan of a software program, in accordance with embodiments of the present invention.

FIG. 9 is a flow chart of a process describing implementation of a step of FIG. 8 in which tagged event nodes of the event hierarchy are mapped to respective event categories within an industry data structure, in accordance with embodiments of the present invention.

FIG. 10 is a flow chart of a process describing implementation of a step of FIG. 8 in which leaf nodes of event hierarchy are classified as metadata nodes, in accordance with embodiments of the present invention.

FIG. 11 is a flow chart of a process describing implementation of a step of FIG. 8 in which parameter nodes are added to the parameter hierarchy and event nodes are added to the event hierarchy, in accordance with embodiments of the present invention.

FIG. 12 illustrates a computer system, in accordance with embodiments of the present invention.

FIG. 13 depicts a computing environment which contains an example of an environment for the execution of at least some of the computer code involved in performing the inventive methods, in accordance with embodiments of the present invention.

### DETAILED DESCRIPTION

According to an aspect of the invention, one or more processors of a computer system perform a dynamic scan of log data generated from multiple executions of a software program that executes events. The dynamic scan identifies a plurality of events that occurred and identifies event triggers that invoked the identified events or invoked other event triggers. The one or more processors generate an event hierarchy by organizing the identified events and identified event triggers into the event hierarchy of N levels denoted as levels 1, . . . , N wherein N is at least 2. The event hierarchy comprises event nodes and event edges. Each event edge connects two event nodes disposed at successive levels of the N levels. The event nodes of level N are leaf nodes. Each leaf node comprises program code whose execution performs one event of the identified events. The event nodes of levels 1, . . . , N−1 are trigger nodes encompassing the identified event triggers and respectively triggering event nodes 2, . . . , N. The one or more processors tag each event node satisfying criteria involving a frequency of occurrence of the events directly or indirectly invoked by each event node. The one or more processors generate an event message having a header portion and a body portion. The body portion comprises attributes of the plurality of events. The header portion comprises an identification of all tagged event nodes. The one or more processors send the header portion, but not the body portion, of the event message to all event subscribers who are subscribed to at least one event of the plurality of events.

The preceding aspect of the invention advantageously sends to event subscribers only the header portion, and not the body portion, of the event message and identifies, in the header portion of the event message, only the tagged events because only the tagged events have a sufficiently high frequency of occurrence, which avoids the computer time of writing events and event attributes not likely to be needed by the event subscribers and enables the event subscribers to subsequently access only those events that the event subscriber needs to access and avoids the event consumer having to review a large number of unneeded events and event attributes.

In first embodiments, the one or more processors perform a static scan of the software program. The static scan identifies parameters whose value may be changed in accordance with events. The parameters are variables in the software program. The one or more processors generate a parameter hierarchy by organizing the identified parameters into the parameter hierarchy of M levels denoted as levels 1, . . . , M wherein M is at least 2. The parameter hierarchy comprises parameter nodes and parameter edges. Each parameter edge connects two parameter nodes disposed at successive levels of the M levels. The parameter nodes of level M are leaf nodes. Each leaf node encompasses one parameter of the identified parameters. Each parameter node of level 1, . . . , M−1 is an aggregation node respectively encompassing all parameter nodes at level 2, . . . , M to which each parameter node is connected by a parameter edge. The one or more processors map the event nodes of the event hierarchy to parameter nodes of the parameter hierarchy.

The preceding first embodiments provide a technical feature of mapping event nodes of the event hierarchy to parameter nodes of the parameter hierarchy, which advantageously identifies those parameters in the parameter hierarchy that have been involved in events that have actually occurred and eliminates from consideration those parameters in the parameter hierarchy not associated with events that have not actually occurred.

In second embodiments, the one or more processors map, using the mapping of the event nodes of the event hierarchy to parameters in the parameter hierarchy, the tagged nodes of the event hierarchy to respective event categories within an industrial data structure. Each event category encompasses at least one category variable identified in the industrial data structure. The mapping of the tagged nodes comprises: using mapped event nodes of the event hierarchy to parameters in the parameter hierarchy to identify a specific parameter in the parameter hierarchy to which a tagged node of the event hierarchy is mapped; and after the specific parameter in the parameter hierarchy is identified, using similarity analysis to match the specific parameter to an event category in the industrial data structure.

The preceding second embodiments provides a technical feature of providing a linkage between events that have occurred and event categories within an industrial data structure. Such linkage advantageously conforms the events that have occurred to industry standards in a manner that facilitates generation of metadata event nodes as well as new parameter and event nodes that can be added to the parameter hierarchy and event hierarchy as discussed infra for third embodiments and fourth embodiments, respectively.

In third embodiments, the following scenario applies. A first trigger node of the event hierarchy is a parent node to a plurality of leaf nodes of the event hierarchy. The tagging results in each leaf node of the plurality of leaf nodes being tagged and the first trigger node not being tagged. The mapping the tagged event nodes results in the first trigger node being mapped to a first event category in the industrial data structure and each leaf node of the plurality of leaf nodes not being mapped to any event category in the industrial data structure. In response to the preceding scenario and after the tagged event nodes are mapped to respective event categories within an industry data structure and before the header portion of the event message is sent: each leaf node of the plurality of leaf nodes is untagged; the first trigger node is tagged; each leaf node of the plurality of leaf nodes is classified as a metadata node; and each metadata node is inserted into the header portion of the event message.

The preceding third embodiments advantageously provide the technical feature of placing metadata into the header portion of the event message which saves computing time and memory by avoiding the reading and writing of numerous attributes and enables an event subscriber to look at only the metadata items in the header portion to determine which events to access.

In fourth embodiments, the following scenario applies. The mapping of the event nodes to parameter nodes of parameter hierarchy results in one trigger node of the event hierarchy being mapped to at least one parameter node identified by the parameter hierarchy. The mapping of tagged event nodes in the event hierarchy to respective event categories within an industry data structure results in the one trigger node being mapped to one event category in the industrial data structure, wherein the at least one parameter node comprises at least one parameter, and wherein the one event category encompasses one or more category variables not encompassing the at least one parameter. In response to the preceding scenario: the one or more processors add the one or more category variables to the at least one parameter as leaf nodes aggregated in the parameter hierarchy; and the one or more processors add events corresponding to the one or more category variables as leaf nodes triggered by the one trigger node in the event hierarchy.

The preceding fourth embodiments advantageously provide the technical feature of adding parameter nodes to the parameter hierarchy and corresponding event nodes to the event hierarchy, which avoids frequent updates of adding new parameters and corresponding events each time new parameters and associated events become relevant. Without this technical feature, numerous subscribers would have to change their software to accommodate new parameters and associated events, so that the speed of software development would tend to become significantly slower and, in some instances, software development may stop completely. Thus, this technical feature saves computer time and computer resources due to the speed of software development being significantly improved.

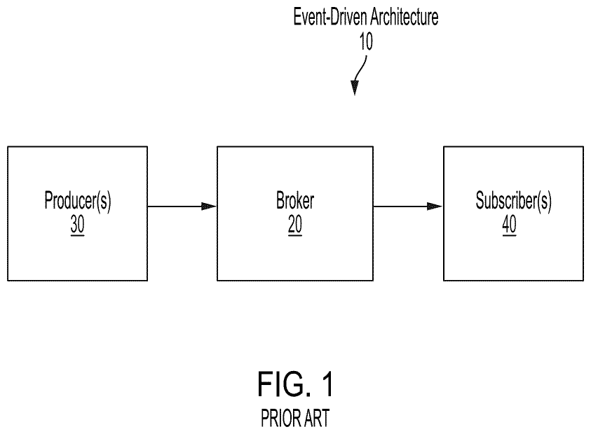

FIG. 1 is a conventional event-driven architecture 10, in accordance with the prior art.

An event is defined as any action, change, or occurrence such as, inter alia: a sensor detecting a change in temperature or pressure; a change from a liquid state to a gaseous state, or vice versa, of a fluid; a change from an open state to a closed state, or vice versa, of a valve; receiving, by an online website, an order for a product or service; completion of a transaction; updating a parameter; etc.

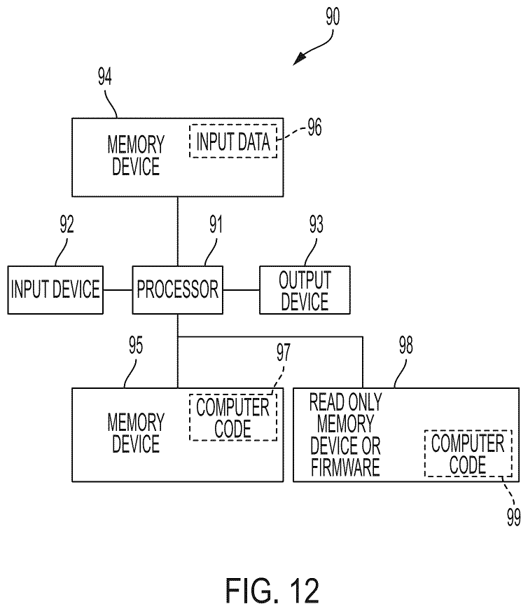

The event-driven architecture 10 includes one or more producers 30, one or more subscribers 40, and a broker 20. The one or more producers 30, the one or more subscribers 40, and the broker 20 are each a computer system such as, inter alia, the computer system 90 of FIG. 12 described infra.

The one or more producers 30 produce event messages that identify one or more events that have occurred. The one or more subscribers 40 subscribe to events which may include at least one event of the one or more events. The broker 20 receives the event messages from the one or more producers 30, processes the received event messages, and selectively sends the event messages to the one or more subscribers 40 based on which events the one or more subscribers 40 are subscribed to.

Disadvantages of the conventional event-driven architecture 10 include, inter alia: inefficient and awkward event schema that define events; frequent additions of new parameters that are, or may be, changed by events; inefficient processing, by the by the one or more subscribers 40, of event messages produced by the one or more producers 30; etc.

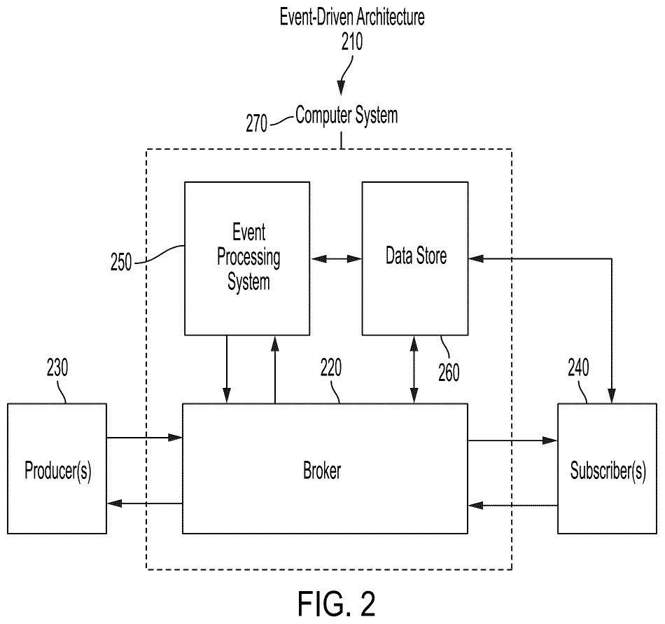

FIG. 2 is an event-driven architecture, in accordance with embodiments of the present invention.

The event-driven architecture 210 includes a computer system 270, one or more producers 230, one or more subscribers 240. The computer system 270 includes a broker 220, an event processing system 250, and a data store 260. The one or more producers 230, which are essentially the same producers as the one or more producers 30 of FIG. 1, produce messages that identify one or more events that have occurred. The one or more subscribers 240, which are essentially the same subscribers as the one or more subscribers 40 of FIG. 1, subscribe to events which may include at least one event of the one or more events.

The one or more producers 230 and the one or more subscribers 240 are each a computer system such as, inter alia, the computer system 90 of FIG. 12 described infra.

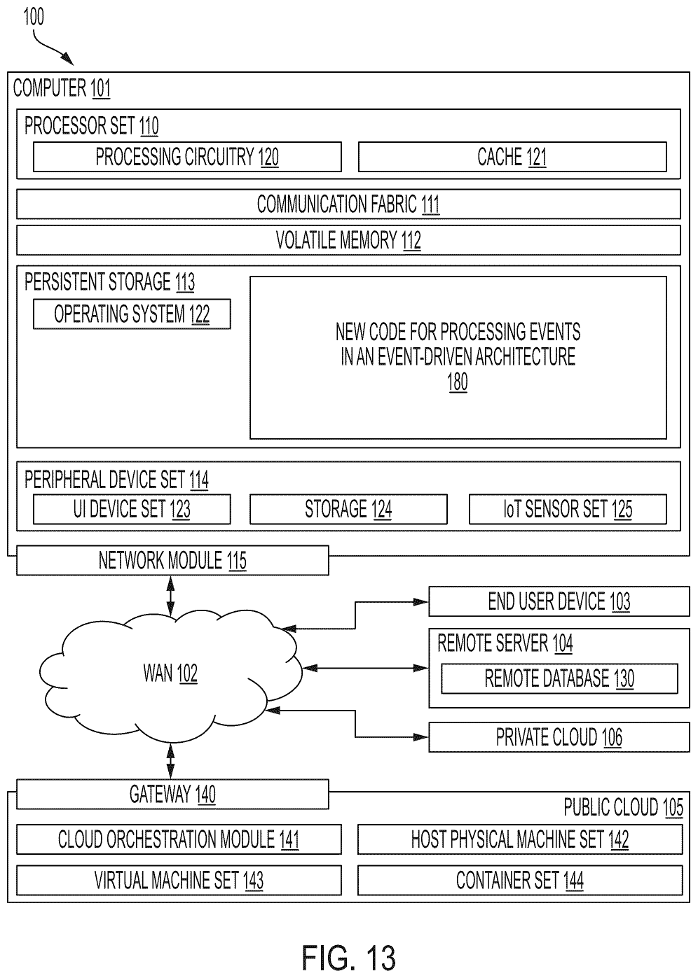

The computer system 270, the event processing system 250, and the broker 220 are each: (i) a computing environment such as, inter alia, the computing environment 100 of FIG. 13 described infra; and/or a computer system such as, inter alia, the computer system 90 of FIG. 12 described infra.

Unlike the broker 30 of FIG. 1 which exclusively processes the event messages received from one or more producers 30 before selectively sending the event messages to the one or more subscribers 40, the broker 230 and the event processing system 250 collectively process the event messages received from one or more producers 230 before selectively sending the event messages to the one or more subscribers 240 or before the subscribers access event attributes. Specifically, the event processing system 250 adds inventive technical features, advantages, and improvements to the processing of the event messages as discussed supra and as will also be discussed infra. Such inventive technical features, advantages, and improvements do not exist in the prior art.

In one embodiment, the broker 230 and the event processing system 250 exist separately as shown in FIG. 2. In one embodiment, the broker 230 comprises the event processing system 250. In one embodiment, the event processing system 250 comprises the broker 230.

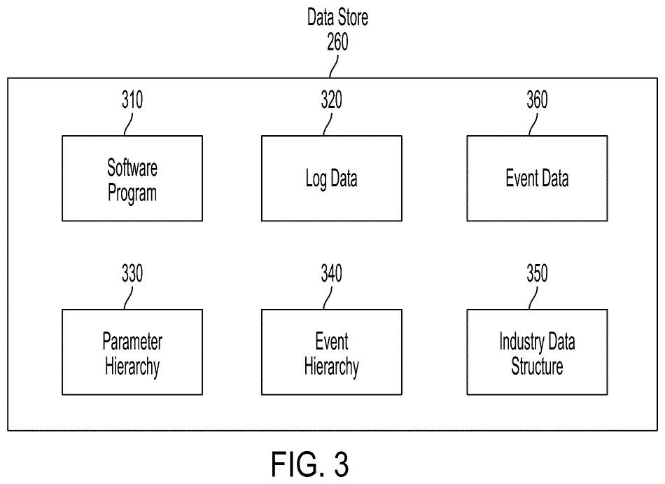

The data store 260, which is described infra in conjunction with FIG. 3, is coupled to and thus available to the event processing system 250, the broker 220, and the subscribers 240.

FIG. 3 depicts the data store 260 that is within the event-driven architecture 210 of FIG. 2, in accordance with embodiments of the present invention.

The data store 260 includes software program 310, log data 320, parameter hierarchy 330, event hierarchy 340, industry data structure 350, and event data 360. The data store 260 may be accessed (for reading and/or writing) by the event processing system 250, the broker 220, and the subscribers 240 via communication links depicted in FIG. 2.

The log data 320 includes logs of events that occurred and the software program 310 includes program code that generates the log data 320. In one embodiment, the broker 220 and/or the event processing system 250 of FIG. 2 comprises the software program 310.

The parameter hierarchy 330 is generated from a static scan discussed infra.

The event hierarchy 340 is generated from a dynamic scan discussed infra.

The industry data structure 350 includes event categories in accordance with industry standards.

The event data 360 stores the events existing in the log data 310. The events in the event data 360 include the attributes of the events and are identified by an event identifier assigned to each event. Events may be selectively read from the event data 360 via use of the event identifier.

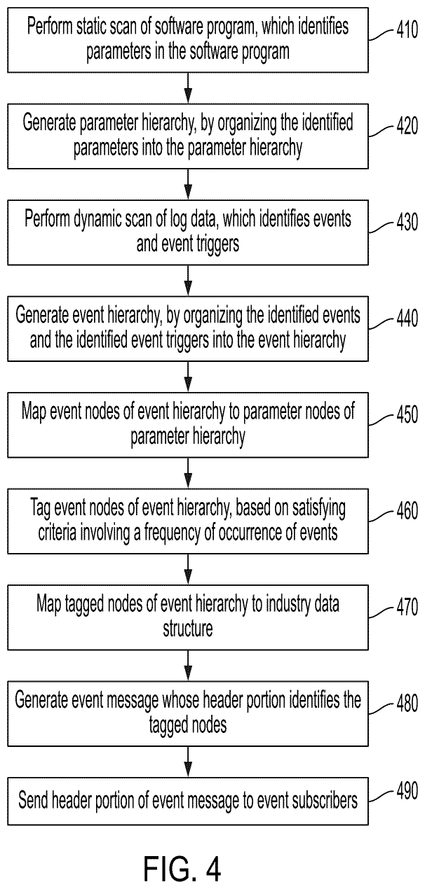

FIG. 4 is a flow chart of a method for processing events in an event-driven architecture, in accordance with embodiments of the present invention. The method of FIG. 4, which may be performed by the computer system 270 of FIG. 2, includes steps 410-490.

Step 410 performs a static scan of the software program 310 (see FIG. 3) that executes events. The static scan identifies parameters whose value may be changed in accordance with events. The parameters are variables in the software program.

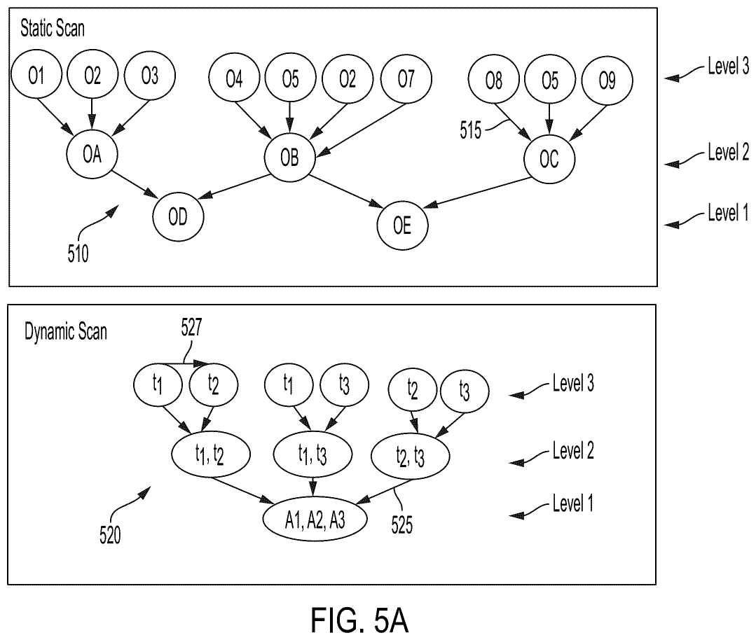

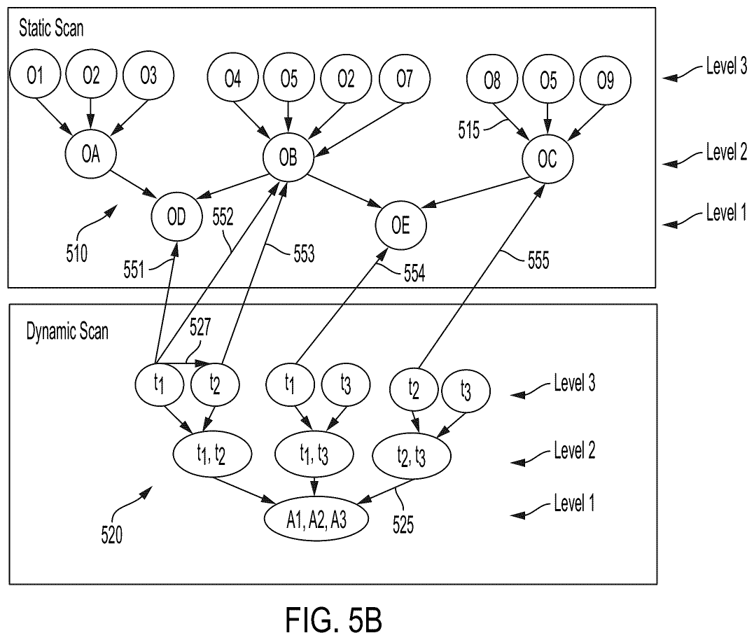

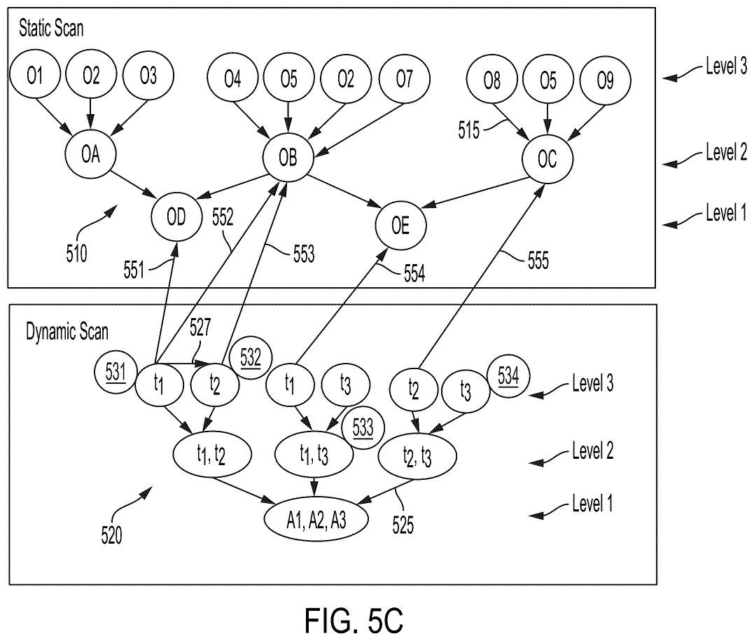

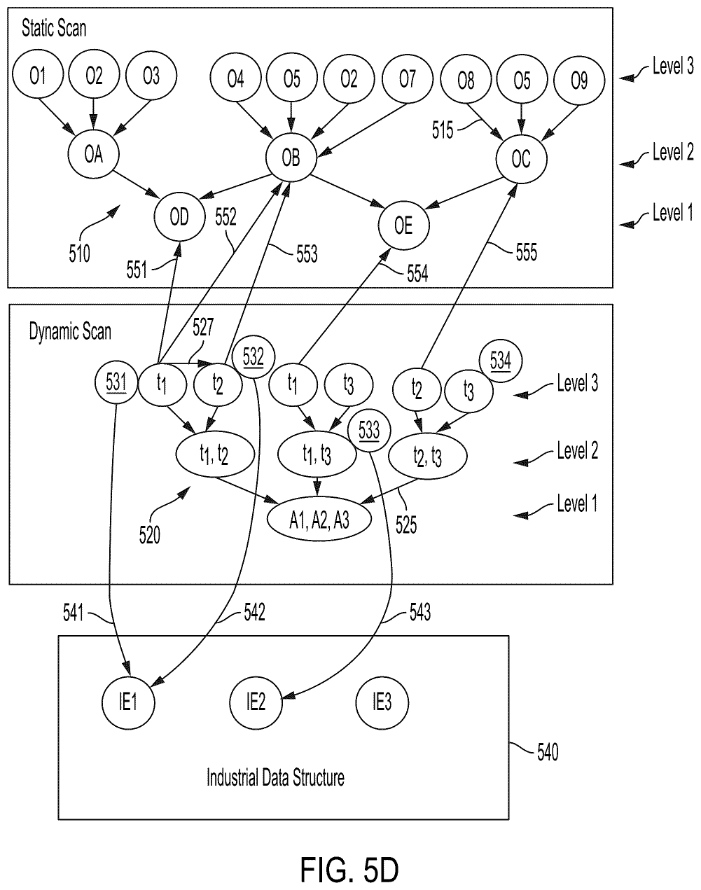

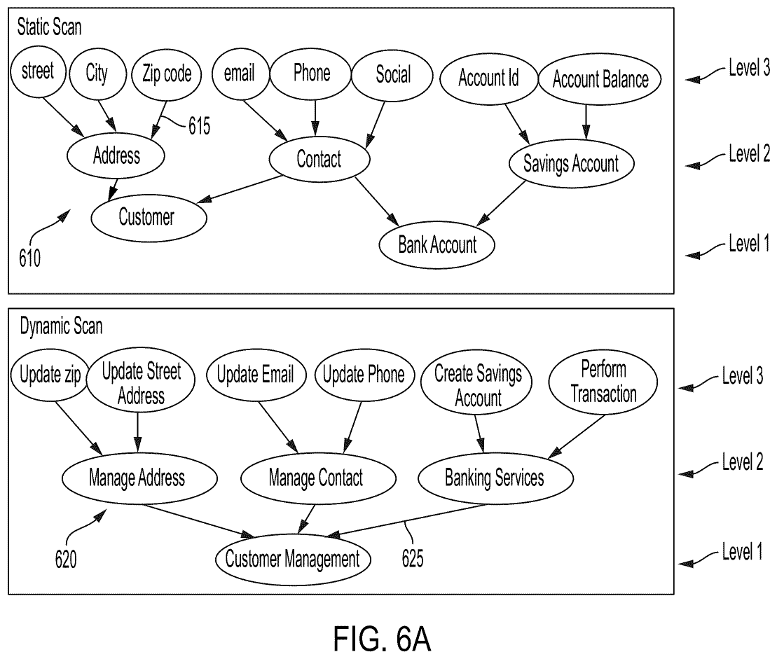

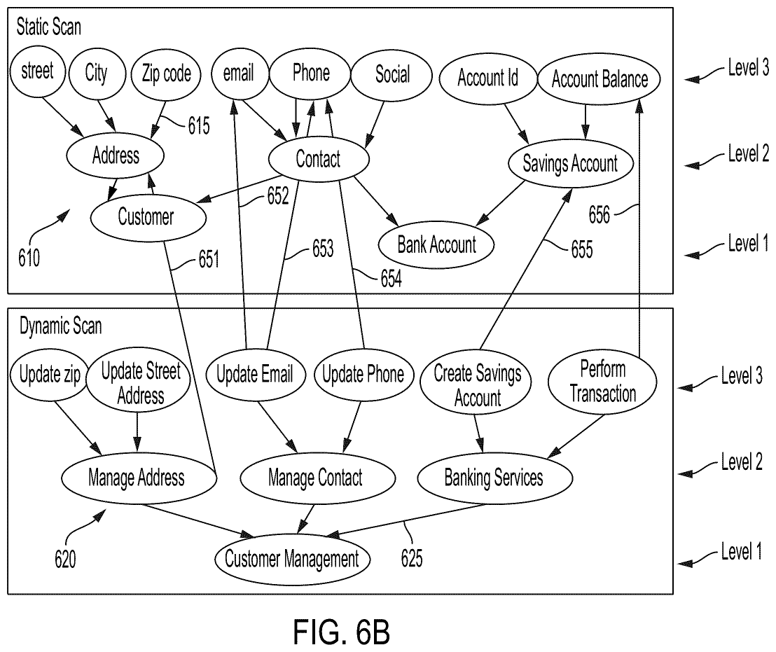

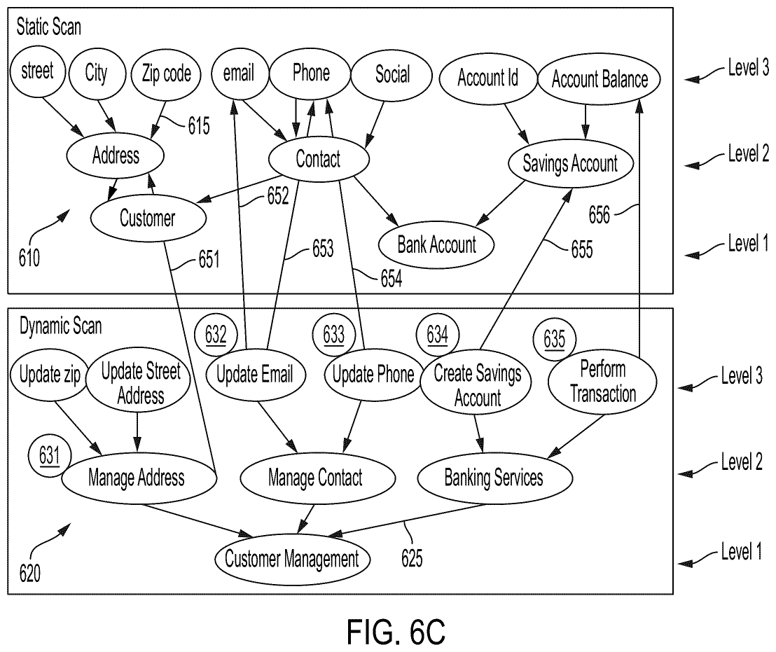

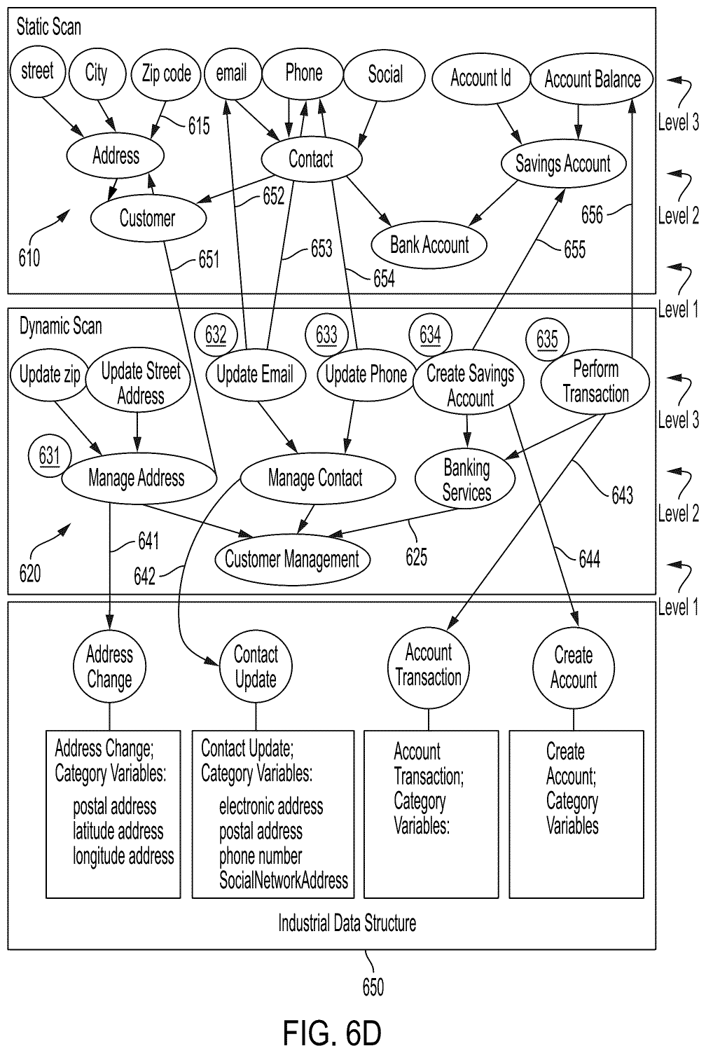

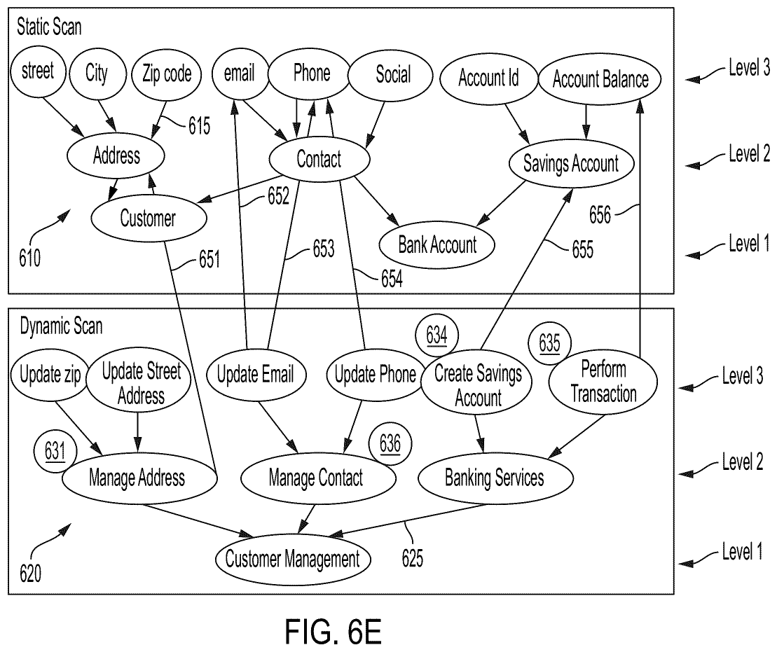

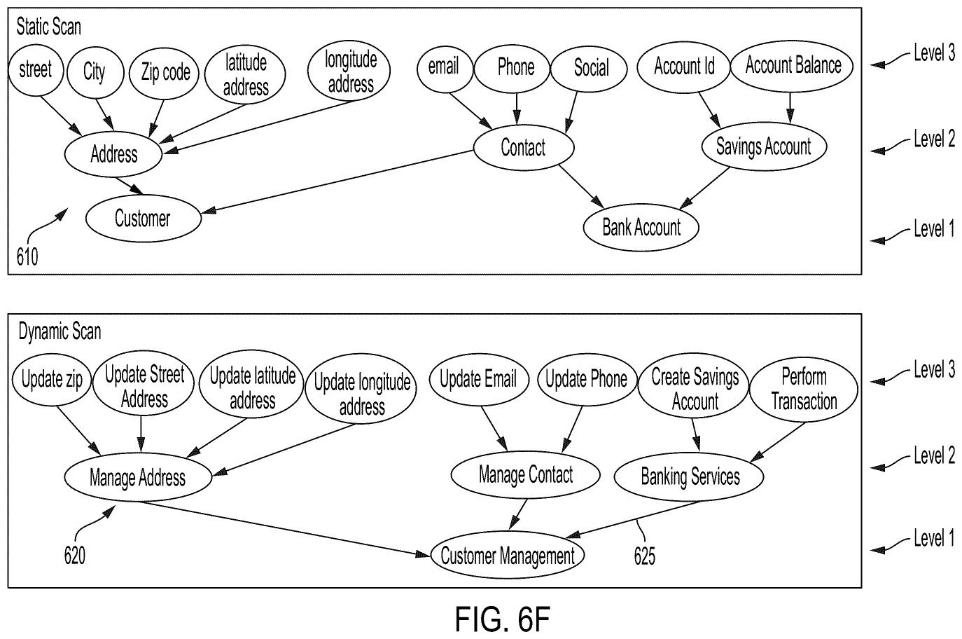

Step 420 generates a parameter hierarchy, by organizing the identified parameters into the parameter hierarchy of M levels denoted as levels 1, . . . , M wherein M is at least 2. The parameter hierarchy comprises parameter nodes and parameter edges. Each parameter edge connects two parameter nodes disposed at successive levels of the M levels. The parameter nodes of level M are leaf nodes. Each such leaf node encompasses one parameter of the identified parameters. Each parameter node of level 1, . . . , M−1 is an aggregation node respectively encompassing all parameter nodes at level 2, . . . , M to which each parameter node is connected by a parameter edge. The parameter hierarchy (e.g., parameter hierarchy 330 of FIG. 3) is illustrated by an exemplary parameter hierarchy 510, in a form of a graph, described infra in conjunction with FIG. 5A and an exemplary parameter hierarchy 610 described infra in conjunction with FIG. 6A.

Step 430 performs a dynamic scan of log data generated from multiple executions of the software program 310 (see FIG. 3). The dynamic scan identifies a plurality of events that occurred and identifies event triggers that invoked the identified events or invoked other event triggers.

The dynamic scan may be performed concurrently in real time while the software program 310 is running or can be performed after the software program 310 has completed its running.

Step 440 generates an event hierarchy, by organizing the identified events and identified event triggers into the event hierarchy of N levels denoted as levels 1, . . . , N wherein N is at least 2. The event hierarchy comprises event nodes and event edges. Each event edge connects two event nodes disposed at successive levels of the N levels. The event nodes of level N are leaf nodes. Each leaf node comprises program code whose execution performs one event of the identified events. The event nodes of levels 1, . . . , N−1 are trigger nodes encompassing the identified event triggers and respectively triggering event nodes 2, . . . , N. The event hierarchy (e.g., event hierarchy 340 of FIG. 3) is illustrated by an exemplary event hierarchy 520, in a form of a graph, described infra in conjunction with FIG. 5A and an exemplary event hierarchy 620 described infra in conjunction with FIG. 6A.

Step 450 maps event nodes of the event hierarchy to parameter nodes of the parameter hierarchy, as illustrated in FIG. 5B described infra and FIG. 6B described infra.

Step 460 tags event nodes of the event hierarchy, based on each event node satisfying criteria involving a frequency of occurrence of the events directly or indirectly performed by execution of each event node, as illustrated in FIG. 5C described infra and FIG. 6C described infra.

Step 470 maps tagged nodes of the event hierarchy to respective event categories within an industrial data structure, wherein each event category encompasses at least one category variable identified in the industrial data structure, as illustrated in FIG. 5D described infra and FIG. 6D described infra.

Step 480 generates an event message having a header portion and a body portion. The body portion comprises attributes of events of the plurality of events. The header portion comprises an identification of all tagged event nodes.

Step 490 sends the header portion, but not the body portion, of the event message to all event subscribers who are subscribed to at least one event of the plurality of events. A subscriber receiving the header portion of the event message may determine, from the tagged nodes in the header portion and from metadata in the header portion, which events to retrieve from the event data 360 in the data store 260. Placement of metadata in the header portion will be discussed infra.

FIG. 5A-5D illustrate steps 410-470 of the method of FIG. 4, in accordance with first embodiments of the present invention.

FIG. 5A depicts an illustrative parameter hierarchy 510 in a form of a graph and an illustrative event hierarchy 520 in a form of a graph, in accordance with embodiments of the present invention.

The parameter hierarchy 510 illustrates an embodiment of a parameter hierarchy generated in step 420 of FIG. 4 and includes parameter nodes 01, 02, 03, 04, 05, 02, 07, 08, 05, 09, 0A, 0B, 0C, 0D, and 0E of parameters identified from the static scan performed in step 410 of FIG. 4.

The parameter nodes exist at levels 1, 2 and 3 of the parameter hierarchy 510 with parameter nodes 0D and 0E (which are root nodes as well as aggregation nodes) at level 1, parameter nodes 0A, 0B, and 0C at level 2 (which are aggregation nodes), and parameter nodes 01, 02, 03, 04, 05, 02, 07, 08, 05, and 09 (which are leaf nodes) at level 3. Generally, the parameter hierarchy has M levels wherein M is at least 2, and M=3 for the parameter hierarchy 510 in FIG. 5A. The parameter nodes at level M are leaf nodes.

The parameter nodes at level m are parent parameter nodes of the parameter nodes at level m+1, and the parameter nodes at level m+1 are child parameter nodes of the parameter nodes at level m (m=1, . . . , M−1). For example, the parameter nodes at level 1 are parent parameter nodes of the parameter nodes at level 2, and the parameter nodes at level 2 are child parameter nodes of the parameter nodes at level 1.

The parameter nodes at level m are grandparent parameter nodes of the parameter nodes at level m+2, and the parameter nodes at level m+2 are grandchild parameter nodes of the parameter nodes at level m (m=1, . . . , M−2). For example, the parameter nodes at level 1 are grandparent parameter nodes of the parameter nodes at level 3, and the parameter nodes at level 3 are grandchild parameter nodes of the parameter nodes at level 1.

Each parameter node comprises a parameter that may be processed by the software code 310 of FIG. 3.

Successive parameter nodes of the parameter hierarchy 510 are connected by parameter edges. For example, parameter edge 515 connects parameter nodes 08 and 0C.

An aggregation node is a parameter node that aggregates all parameter nodes, existing at the next highest level, to which the aggregation node is directly connected by a parameter edge. For example, aggregation node 0A at level 2 aggregates parameter nodes 01, 02, and 03 at level 3 and thus includes parameter nodes 01, 02, and 03. As another example, aggregation node 0D at level 1 aggregates parameter nodes 0A and 0B at level 2 and thus includes parameter nodes 0A and 0B which, in turn, includes parameter nodes 01, 02, 03 and parameter nodes 04, 05, 02, and 07, respectively.

The parameter hierarchy 510 encompasses continuous paths from parameter node 1 to parameter node M (i.e., from a root node to a leaf node). Examples of such paths include a path through parameter nodes 0D, 0A, and 01. Another example of such paths include a path through parameter nodes 0E, 0B, and 04.

The leaf nodes in parameter hierarchy 510 are not required to be unique. For example, parameter nodes 02 and 05 each exists as two independent leaf nodes in level 3.

Although, the parameter hierarchy 510 is a particular configuration of parameter nodes, the parameter hierarchy of the present invention is not limited to any specific configuration of parameter nodes.

The event hierarchy 520 illustrates an embodiment of an event hierarchy generated in step 440 of FIG. 4 and consists of event nodes t₁, t₂, and t₃ in different combinations. Each different combination of event nodes t₁, t₂, and t₃ is a different event node, and all combinations of event nodes t₁, t₂, and t₃ are represented in the specific embodiment of event hierarchy 520. The leaf nodes t₁, t₂, and t₃ are blocks of program code configured to perform respective events e₁, e₂, and e₃ identified from the dynamic scan performed in step 430 of FIG. 4. For example, event node (t₁, t₂) performs respective events e₁ and e₂, in combination (i.e., jointly or together).

The right arrow 527 between event nodes t₁ and t₂ indicates that event node t₂ is executed after execution of event node t₁ has been completed.

The parentheses ( ) as illustrated by (t₁, t₂), denotes a combination of event nodes t₁ and event node t₂ (i.e., events t₁ and t₂ are executed jointly or together).

The event nodes exist at levels 1, 2 and 3 of the event hierarchy 520 and include: event node (A1, A2, A3) (which is a root node as well as a trigger node) at level 1; event nodes (t₁, t₂), (t₁, t₃), (t₂, t₃) (which are trigger nodes) at level 2; and event nodes t₁, t₂, t₁, t₃, t₂, t₃ (which are leaf nodes) at level 3. Generally, the event hierarchy has N levels wherein N is at least 2 and N=3 for the event hierarchy 520 in FIG. 5A. The event nodes at level N are leaf nodes.

Successive event nodes of the event hierarchy 520 are connected by event edges. For example, event edge 525 connects event nodes (t₂, t₃) and (A1, A2, A3).

A trigger node is an event node that is a block of program code which triggers all event nodes, at the next highest level, to which the trigger node is directly connected by an event edge. For example, trigger node (t₁, t₂) at level 2 triggers event nodes t₁ and t₂ at level 3 and thus comprise event nodes t₁ and t₂. As another example, trigger node (A1, A2, A3) at level 1 triggers event nodes (t₁, t₂), (t₁, t₃), and (t₂, t₃) at level 2 and thus comprise event nodes (t₁, t₂), (t₁, t₃), and (t₂, t₃) which, in turn, respectively comprise event nodes (t₁ and t₂), (t₁ and t₃), and (t₂ and t₃). It is noted that A1, A2, and A3 stand for (t₁, t₂), (t₁, t₃), and (t₂, t₃), respectively.

The event hierarchy 520 encompasses continuous paths from node 1 to node N (i.e., from a root node to a leaf node). Examples of such paths include a path through nodes (A1, A2, A3), (t₁, t₂), and t₁. Another example of such paths include a path through nodes (A1, A2, A3), (t₁, t₃), and t₃.

Although all combinations of event nodes t₁, t₂, and t₃ are represented in the embodiment of event hierarchy 520, all combinations of the event nodes are not represented in the event hierarchy in other embodiments.

The leaf nodes in event hierarchy 520 are not required to be unique. For example, leaf nodes t₁, t₂, and t₃ each exists as two independent leaf nodes in level 3.

Although, the event hierarchy 520 is a particular configuration of event nodes, the event hierarchy of the present invention is not limited to any specific configuration of event nodes.

FIG. 5B depicts mapping the event hierarchy 520 to the parameter hierarchy 510 in FIG. 5A, as performed in step 450 of FIG. 4, in accordance with the embodiments of the present invention. The mapping in FIG. 5B illustrates step 450 of FIG. 4 and is performed using both the parameter hierarchy 510 and the dynamic hierarchy 520. The mapping in FIG. 5B shows which parameter nodes in the parameter hierarchy 510 are used by the blocks of code of the event nodes in the event hierarchy 520. For example, the mapping 555 shows that parameter 0C in the parameter hierarchy 510 is used by the program code of the event in event node t₂ of the event hierarchy 520.

The mappings of the event nodes in event hierarchy 520 to parameter nodes in the parameter hierarchy 510 shown in FIG. 5B include: event node t₁ mapped to parameter node 0D in mapping 551, event node t₁ mapped to parameter node 0B in mapping 552, event node t₂ mapped to parameter node 0D in mapping 553, event node t₁ mapped to parameter node 0E in mapping 554, and event node t₂ mapped to parameter node 0C in mapping 555.

FIG. 5C depicts tagging of event nodes in the event hierarchy 520 of FIG. 5B, in accordance with embodiments of the present invention. The tagging in FIG. 5C illustrates step 460 of FIG. 4.

In FIG. 5C, the tagged event nodes are t₁ having tag 531; t₂ having tag 532; (t₁, t₃) having tag 533, and t₃ having tag 534.

A “tag” is any data value (number, character, character string, etc.) that characterizes an event node as being tagged to distinguish other event nodes that are not tagged.

The tagging of event nodes in FIG. 5C is based on each event node satisfying criteria involving a frequency of occurrence of the events directly or indirectly invoked by each event node. The frequency of occurrence of the events is determined from the log data 320 of FIG. 3.

In one embodiment, a single event node, in a path of the event hierarchy 520, whose event has a highest frequency of occurrence, as compared with all other events in the path (as inferred from the log data 320), is tagged. For example in the embodiment, in the path (A1, A2, A3), (t₂, t₃), t₃, the event node t₃ is tagged with tag 534, because the event node t₃ has a highest frequency of occurrence in this path as compared with event nodes (A1, A2, A3) and (t₂, t₃).

In one embodiment, all event nodes, in a path of the event hierarchy 520, whose associated event has a frequency of occurrence that is equal to or greater than a specified frequency threshold (as inferred from the log data 320) is tagged.

In one embodiment, all event nodes, in the event hierarchy 520, whose associated event has a frequency of occurrence that is equal to or greater than a specified frequency threshold (as inferred from the log data 320) is tagged. For example in the embodiment, the event nodes t₁, t₂, (t₁, t₃), and t₃ have respective tags 531, 532, 533, and 534, because the preceding event nodes each have a frequency of occurrence that is equal to or greater than a specified frequency threshold.

A frequency of occurrence of an event is calculated as Ne/Δt, where Δt is a specified time interval within a total time of the log data 320 and Ne is a number of occurrences of the event over the specified time interval Δt.

The tagging of event nodes t₁ and t₂ having tags 531 and 532, respectively, with no tagging of event node (t₁, t₂), illustrates that event nodes t₁ and t₂ each have a high frequency of being executed independently of each other and do not have a high frequency of being executed together or jointly.

The tagging of event node (t₁, t₃) having tag 533, with no tagging of event nodes t₁ and t₃, illustrates that event nodes t₁ and t₃ have a high frequency of being executed together or jointly and do not have a high frequency of being executed independently of each other.

The tagging of event node t₃ having tag 534, with no tagging of event nodes t₂ and (t₂, t₃), illustrates that: (i) event node t₃ has a high frequency of being executed independently, and (ii) event node t₂ does not have a high frequency of being executed independently, and (iii) event nodes t₂ and t₃ do not have a high frequency of being executed together or jointly.

FIG. 5C illustrates an embodiment in which after the event nodes are tagged, each path in the event hierarchy 520 includes no more than one tagged event node. More specifically, all paths in the event hierarchy 520 includes one and only one, tagged node, with an exception of the path t₂, (t₂, t₃), and (A1, A2, A3) which does not include any tagged node.

FIG. 5D depicts mapping of a subset of the tagged nodes of FIG. 5C to respective event categories within an industrial data structure 540, in accordance with embodiments of the present invention. The mapping in FIG. 5D illustrates step 470 of FIG. 4.

The event categories in the industrial data structure 540 are IE1, IE2, and IE3. Each event category encompasses at least one category variable included within the industrial data structure 540 (not explicitly shown in FIG. 5D).

The mappings in FIG. 5D are: mapping 541 of tagged event node t₁ (having tag 531) to event category IE1, mapping 542 of tagged event node t₂ (having tag 532) to event category IE1, and mapping 543 of tagged event node (t₁, t₃) (having tag 533) to event category IE2. Tagged event node t₃ (having tag 534) is not mapped to any event category.

The mappings in FIG. 5D utilizes the parameter hierarchy 510, by using the mapping of the event hierarchy 520 to the parameter hierarchy 510 to identify a specific parameter in the parameter hierarchy 510 to which a tagged node of the event hierarchy 520 is mapped, followed by using similarity analysis to match the specific parameter to an event category in the industrial data structure 540.

For example, tagged nodes t₁ and t₂ (having tags 531 and 532, respectively) in the event hierarchy 520 are each mapped to the specific parameter 0B in the parameter hierarchy 510. Then, the specific parameter 0B is matched via similarity analysis to the event category IE1 in the in the industrial data structure 540, from which it is inferred that the tagged nodes t₁ and t₂ in the event hierarchy 520 are each mapped to the event category IE1 in the industrial data structure 540, depicted in mappings 541 and 542, respectively, in FIG. 5D.

Similarity analysis is a process of quantifying similarity between different data objects and in particular for quantifying similarity between a parameter in the parameter hierarchy 510 and an event category in the in the industrial data structure 540. Such quantifying is via use of a metric known in the art such as, inter alia, Euclidean distance, cosine similarity, etc.

FIG. 6A-6D illustrate steps 410-470 of the method of FIG. 4, in accordance with second embodiments of the present invention.

FIG. 6A depicts an illustrative parameter hierarchy 610 and an illustrative event hierarchy 620, in accordance with embodiments of the present invention.

The parameter hierarchy 610 illustrates an embodiment of a parameter hierarchy generated in step 420 of FIG. 4 and includes parameter nodes of parameters street, City, Zip code, email, Phone, Social, Account id, Account Balance, Address, Contact, Savings Account, Customer, and Bank Account, identified from the static scan performed in step 410 of FIG. 4.

The parameter nodes exist at levels 1, 2 and 3 of the parameter hierarchy 610 with parameter nodes of parameters Customer and Bank Account (which are root nodes as well as aggregation nodes) at level 1, parameter nodes of parameters Address, Contact, Savings Account (which are aggregation nodes) at level 2, and parameter nodes of parameters Street, City, Zip code, email, Phone, Social, Account id, and Account Balance (which are leaf nodes) at level 3. Generally, the parameter hierarchy has M levels wherein M is at least 2 and M=3 for the parameter hierarchy 610 in FIG. 6A. The parameter nodes at level M are leaf nodes.

The parameter nodes at level m are parent event nodes of the event nodes at level m+1, and the event nodes at level m+1 are child event nodes of the event nodes at level m (m=1, . . . , M−1). For example, the parameter nodes at level 1 are parent event nodes of the event nodes at level 2, and the event nodes at level 2 are child event nodes of the event nodes at level 1.

The parameter nodes at level m are grandparent event nodes of the event nodes at level m+2, and the event nodes at level m+2 are grandchild event nodes of the event nodes at level m (m=1, . . . , M−2). For example, the parameter nodes at level 1 are grandparent event nodes of the event nodes at level 3, and the event nodes at level 3 are grandchild event nodes of the event nodes at level 1.

Each parameter node consists of a parameter that may be processed by the software code 310 of FIG. 3.

Successive parameter nodes of the parameter hierarchy 610 are connected by parameter edges. For example, parameter edge 615 connects parameter nodes Zip Code and Address.

An aggregation node is a parameter node that aggregates all parameter nodes, at the next highest level, to which the aggregation node is directly connected by a parameter edge. For example, aggregation node Address at level 2 aggregates parameter nodes street, City, and Zip code at level 3 and thus includes parameter nodes street, City, and Zip code. As another example, aggregation node Customer at level 1 aggregates parameter nodes Address and Contact at level 2 and thus includes parameter nodes Address and Contact.

The parameter hierarchy 610 encompasses continuous paths from node 1 to node M (i.e., from a root node to a leaf node). Examples of such paths include a path through nodes Customer, Address, and street. Another example of such paths include a path through nodes Bank Account, Contact, and Phone.

The leaf nodes in parameter hierarchy 610 are unique but are not required to be unique.

Although, the parameter hierarchy 610 is a particular configuration of parameter nodes, the parameter hierarchy of the present invention is not limited to any specific configuration of parameter nodes.

The event hierarchy 620 illustrates an embodiment of an event hierarchy generated in step 440 of FIG. 4 and includes event nodes Update zip, Update Street Address, Update Email, Update Phone, Create Savings Account, Perform Transaction, Manage Address, Manage Contact, Banking Services, and Customer Management.

The leaf nodes are blocks of program code configured to perform respective events that were identified from the dynamic scan performed in step 430 of FIG. 4. For example, event node Update Email performs the event of updating email.

The event nodes exist at levels 1, 2 and 3 of the event hierarchy 620, with event node Customer Management (which is a root node as well as an aggregation node) at level 1, event nodes Manage Address, Manage Contact, and Banking Services (which are trigger nodes) at level 2, and event nodes street, City, Zip code, email, Phone, Social, Account id, and Account Balance (which are leaf nodes) at level 3. Generally, the event hierarchy has N levels wherein N is at least 2 and N=3 for the event hierarchy 620 in FIG. 6A. The event nodes at level N are leaf nodes.

Successive event nodes of the event hierarchy 620 are connected by event edges. For example, event edge 625 connects event nodes Banking Services and Customer Management.

A trigger node is an event node that is a block of program code which triggers all event nodes, at the next highest level, to which the trigger node is directly connected by an event edge. For example, trigger node Manage Address at level 2 triggers event nodes Update zip and Update Street Address at level 3 and thus includes event nodes Update zip and Update Street Address. As another example, trigger node Customer Management at level 1 triggers event nodes Manage Address, Manage Contact, and Banking Services at level 2 and thus includes event nodes Manage Address, Manage Contact, and Banking Services.

The event hierarchy 620 encompasses continuous paths from node 1 to node N (i.e., from a root node to a leaf node). Examples of such paths include a path through nodes Customer Management, Manage Contact, and Update Phone. Another example of such paths include a path through nodes Customer Management, Banking Services, and Perform Transaction.

The leaf nodes in event hierarchy 620 are unique but are not required to be unique.

Although, the event hierarchy 620 is a particular configuration of event nodes, the event hierarchy of the present invention is not limited to any specific configuration of event nodes.

FIG. 6B depicts mapping the event hierarchy 620 to the parameter hierarchy 610 in FIG. 6A, as performed in step 450 of FIG. 4, in accordance with embodiments of the present invention. The mapping in FIG. 6B illustrates step 430 of FIG. 4 and is performed using both the static scan of step 410 and the dynamic scan 420 of FIG. 4, and shows which parameter nodes in the parameter hierarchy 610 are used by the blocks of code of the event nodes in the event hierarchy 620. For example, the mapping 655 shows that parameter Savings Account in the parameter hierarchy 610 is used by the program code of the event in event node Create Savings Account of the event hierarchy 620.

The mappings of the event nodes in event hierarchy 620 to parameter nodes in the parameter hierarchy 610 shown in FIG. 6B include: event node Manage Address mapped to parameter node Address in mapping 651, event node Update Email mapped to parameter node email in mapping 652, event node Update Email mapped to parameter node Phone in mapping 653, event node Update Phone mapped to parameter node Phone in mapping 654, event node Create Savings Account mapped to parameter node Savings Account in mapping 655, and event node Perform Transaction mapped to parameter node Account Balance in mapping 656.

FIG. 6C depicts tagging of event nodes in the event hierarchy 620 of FIG. 6B, in accordance with embodiments of the present invention. The tagging in FIG. 6C illustrates step 460 of FIG. 4

In FIG. 6C, the tagged event nodes are Manage Address having tag 631; Update Email having tag 632; Update Phone having tag 633, and Create Savings Account having tag 634, and Perform Transaction having tag 635.

A “tag” is any data value (number, character, character string, etc.) that characterizes an event node as being tagged to distinguish other event nodes that are not tagged.

The tagging of event nodes in FIG. 6C is based on each event node satisfying criteria involving a frequency of occurrence of the events directly or indirectly invoked by each event node. The frequency of occurrence of the events is determined from the log data 320 of FIG. 3.

In one embodiment, a single event node, in a path of the event hierarchy 620, whose event has a highest frequency of occurrence, as compared with all other events in the path (as inferred from the log data 320), is tagged. For example in this embodiment, in the path Customer Management, Banking services, Perform Transaction, the event node Perform Transaction is tagged with tag 635, because the event node Perform Transaction has a highest frequency of occurrence in this path as compared with event nodes Customer Management and Banking services.

In one embodiment, all event nodes, in a path of the event hierarchy 620, whose associated event has a frequency of occurrence that is equal to or greater than a specified frequency threshold (as inferred from the log data 320) is tagged.

In one embodiment, all event nodes, in the event hierarchy 620, whose associated event has a frequency of occurrence that is equal to or greater than a specified frequency threshold (as inferred from the log data 320) is tagged. For example in this embodiment, the event nodes Manage Address, Update Email, Update Phone, Create Savings Account, and Perform Transaction have respective tags 631, 632, 633, 634, and 635, because the preceding event nodes each have a frequency of occurrence that is equal to or greater than a specified frequency threshold.

In one embodiment, all event nodes, in a path of the event hierarchy 620, whose associated event has a frequency of occurrence that is equal to or greater than a specified frequency threshold (as inferred from the log data 320) is tagged.

A frequency of occurrence of an event is calculated as Ne/Δt, where Δt is a specified time interval within a total time of the log data 320 and Ne is a number of occurrences of the event over the specified time interval Δt.

In FIG. 6C, the tagged event nodes are Manage Address having tag 631, Update Email having tag 632, Update Phone having tag 633, Create Savings Account having tag 634, and Perform Transaction having tag 635.

A “tag” is any data value (number, character, character string, etc.) that characterizes an event node as being tagged to distinguish other event nodes that are not tagged.

The tagging of event nodes Update Email and Update Phone with no tagging of event node Manage Contact illustrates that event nodes Update Email and Update Phone each have a high frequency of being executed independently of each other and do not have a high frequency of being executed together or jointly.

The tagging of event node Manage Address having tag 631 and 532, with no tagging of event nodes Update Zip and Update Street Address, illustrates that event nodes Update Zip and Update Street Address have a high frequency of being executed together or jointly and do not have a high frequency of being executed independently of each other.

FIG. 6C illustrates an embodiment in which after the event nodes are tagged, each path in the event hierarchy 620 includes one, and only one, tagged event node.

FIG. 6D depicts mapping of a subset of the tagged nodes of FIG. 6C to respective event categories within an industrial data structure 650, in accordance with embodiments of the present invention. The mapping in FIG. 6D illustrates step 470 of FIG. 4.

The event categories in the industrial data structure 650 are Address change, Contact Update, Account Transaction, and Create Account.

Each event category encompasses at least one category variable identified in the industrial data structure. For example, the event category of Address change encompasses category variables of postal address, latitude address, and longitude address. The event category of Contact Update encompasses category variables of electronic address, postal address, phone number, and SocialNetworkAddress.

The mappings in FIG. 6D are: mapping 641 of tagged event node Manage Address (having tag 631) to event category Address Change, mapping 642 of event node Manage Contact to event category Contact Update, mapping 643 of tagged event node Perform Transaction (having tag 635) to event category Account Transaction, and mapping 644 of tagged event node Create Savings Account (having tag 634) to event category Create Account. Tagged event nodes Update Email and Update Phone (having tags 632 and 633, respectively) is not mapped to any event category.

Although FIG. 6D depicts the event node Manage Contact as being mapped to event category Contact Update but does not depict the event node Manage Contact as being tagged, the event node Manage Contact will be tagged, in one embodiment, with tag 636 as explained infra in conjunction with FIG. 6E.

The mappings in FIG. 6D utilize the parameter hierarchy 610, by using the mapping of the event hierarchy 620 to the parameter hierarchy 610 to identify a specific parameter in the parameter hierarchy 610 to which a tagged node of the event hierarchy 620 is mapped, followed by using similarity analysis to match the specific parameter to an event category in the industrial data structure 640.

For example, tagged node of Create Savings Account (having tag 634) in the event hierarchy 620 is mapped to the specific parameter Savings Account in the parameter hierarchy 610. Then, the specific parameter Savings Account is matched via similarity analysis to the event category Create Account in the in the industrial data structure 650, from which it is inferred that the tagged node Create Savings Account in the event hierarchy 620 is mapped to the event category Create Account, depicted in mapping 643, in the in the industrial data structure 650.

Similarity analysis is generally a process of quantifying similarity between different data and in particular for quantifying similarity between a parameter in the parameter hierarchy 610 and an event category in the in the industrial data structure 640. Such quantifying is via use of a metric known in the art such as, inter alia, Euclidean distance, cosine similarity, etc.

In addition, FIG. 6D depicts the following conditions. The leaf nodes Update Email is tagged with tag 632 and the leaf mode Update Phone is tagged with tag 633, with the parent event node Manage Contact of leaf nodes Update Email and Update Phone not being tagged. In addition, the parent event node Manage Contact is mapped to the event category of Contact Update in the industrial data structure 650, whereas the leaf nodes Update Email and Update Phone are not mapped to any event category in the industrial data structure 650.

In response to the preceding conditions, FIG. 6E depicts changing event node tags in the event hierarchy 620 of FIG. 6D, in accordance with embodiments of the present invention. As shown in FIG. 6E: the tags 632 and 633 are removed from leaf nodes Update Email and Update Phone; the parent event node Manage Contact is tagged with a new tag 636. In addition, each of the leaf nodes Update Email and Update Phone are classified as metadata nodes; and each of the metadata nodes of Update Email and Update Phone are inserted into the header portion of the event message generated in step 480 of FIG. 4.

The technical feature of placement of metadata into the header portion of the event message saves computing time and memory. Typically, events may include hundreds of attributes and writing data of hundreds of attributes and then reading data of hundreds of attributes is extremely expensive due to making use of lot of computing and lot of memory. Because of the metadata placed in the header portion of the event messaged, subscribers need not look at all the hundred attributes and need not read all the hundred attributes (which us a very expensive operation) but will look at only the metadata items in the header portion to see whether Email and/or Phone is Updated and will decide whether or not to read additional information of this event. For example, if an Update Phone is an operation that the subscriber is interested in and sees from the metadata that only Email is updated, the subscriber can ignore the complete event which will save huge resources (CPU and memory) by ignoring the event completely.

In addition, FIG. 6D depicts the following conditions. The event node Manage Address in level 2 of the event hierarchy 620 maps to the parameter node Address in level 2 of the parameter hierarchy 610 which aggregates leaf nodes of street, City, and Zip code in level 1 of the parameter hierarchy 610. The event node Manage Address in level 2 of the event hierarchy 620 maps to the event category of Address Change in the industrial data structure 650 which encompasses category variables of postal address, latitude address, and longitude address.

Although Address in level 2 of the parameter hierarchy 610 aggregates leaf nodes of street, City, and Zip code Zip code which matches the category variable of postal address in the industrial data structure 650, the category variables of latitude address and longitude address in the industrial data structure 650 are not currently leaf nodes aggregated by Address in level 2 of the parameter hierarchy 610.

In response to the preceding conditions, FIG. 6F depicts adding parameter nodes to the parameter hierarchy 610 and corresponding event nodes to the event hierarchy 620 of FIG. 6A, in accordance with embodiments of the present invention. More specifically, FIG. 6F depicts: (i) adding the category variables of latitude address and longitude address to the parameters of street, City, and Zip code as leaf nodes aggregated by the parameter node Address in the parameter hierarchy 610; and (ii) adding event nodes of Update latitude address and Update longitude address, which respectively correspond to the one or more category variables latitude address and longitude address, as leaf nodes triggered by the Manage Address event node in the event hierarchy 620.

The technical feature of adding parameter nodes to the parameter hierarchy and corresponding event nodes to the event hierarchy avoids frequent updates of adding new parameters and corresponding events each time new parameters and associated events become relevant, which saves computer time and computer resources. In the software industry, the event schema changes can be very detrimental. For example, if there are 100 subscribers and all of the 100 subscribers have to change their software to accommodate new parameters and associated events, the speed of software development tends to become significantly slower and, in some instances, may stop completely. By using this technical feature, the speed at which software is developed and supported is significantly improved.

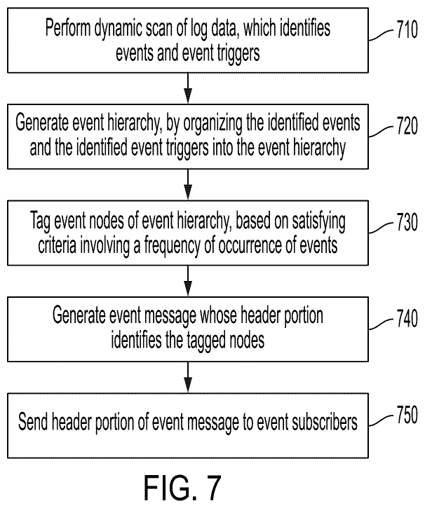

FIG. 7 is a flow chart of a method for processing events in an event-driven architecture based in part on a dynamic scan of log data, in accordance with embodiments of the present invention. The method of FIG. 7, which may be performed by the computer system 270 of FIG. 2, includes steps 710-750.

Step 710 performs a dynamic scan of log data generated from multiple executions of the software program 310 (see FIG. 3). The dynamic scan identifies a plurality of events that occurred and identifies event triggers that invoked the identified events or invoked other event triggers.

The dynamic scan may be performed concurrently in real time while the software program 310 is running or can be performed after the software program 310 has completed its running.

Step 720 generates an event hierarchy, by organizing the identified events and identified event triggers into the event hierarchy of N levels denoted as levels 1, . . . , N wherein N is at least 2. The event hierarchy comprises event nodes and event edges. Each event edge connects two event nodes disposed at successive levels of the N levels. The event nodes of level N are leaf nodes. Each leaf node comprises program code whose execution performs one event of the identified events. The event nodes of levels 1, . . . , N−1 are trigger nodes encompassing the identified event triggers and respectively triggering event nodes 2, . . . , N. The event nodes of levels 1, . . . , N−1 are trigger nodes encompassing the identified event triggers and respectively triggering event nodes 2, . . . , N. The event hierarchy (e.g., event hierarchy 340 of FIG. 3) is illustrated by an exemplary event hierarchy 520 described supra in conjunction with FIG. 5A and an exemplary event hierarchy 620, in a form of a graph, described supra in conjunction with FIG. 6A.

Step 730 tags event nodes of the event hierarchy, based on each event node satisfying criteria involving a frequency of occurrence of the events directly or indirectly performed by execution of each event node, as illustrated in FIG. 5C describe supra and FIG. 6C described supra.

Step 740 generates an event message having a header portion and a body portion. The body portion comprises attributes of the plurality of events. The header portion comprises an identification of all tagged event nodes.

Step 750 sends the header portion, but not the body portion, of the event message to all event subscribers who are subscribed to at least one event of the one or more events. A subscriber receiving the header portion of the event message may determine, from the tagged nodes in the header portion and from metadata in the header portion, which events to retrieve from the event data 360 in the data store 260. Placement of metadata in the header portion will be discussed infra.

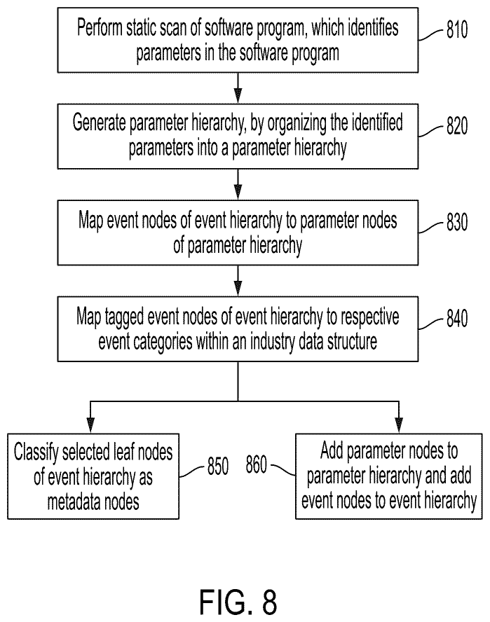

FIG. 8 is a flow chart of processes that enhance the method of FIG. 7 based in part on a static scan of the software program 310, in accordance with embodiments of the present invention. The flow chart of FIG. 4, which may performed by the computer system 270 of FIG. 2, includes steps 810-860.

Step 810 performs a static scan of the software program 310 (see FIG. 3) that executes events. The static scan identifies parameters whose value may be changed in accordance with events. The parameters are variables in the software program.

Step 820 generates a parameter hierarchy, by organizing the identified parameters into the parameter hierarchy of M levels denoted as levels 1, . . . , M wherein M is at least 2. The parameter hierarchy comprises parameter nodes and parameter edges. Each parameter edge connects two parameter nodes disposed at successive levels of the M levels. The parameter nodes of level M are leaf nodes. Each such leaf node encompasses one parameter of the identified parameters. Each parameter node of level 1, . . . , M−1 is an aggregation node respectively encompassing all parameter nodes at level 2, . . . , M to which each parameter node is connected by a parameter edge. The parameter hierarchy (e.g., parameter hierarchy 330 of FIG. 3) is illustrated by an exemplary parameter hierarchy 510, in a form of a graph, described supra in conjunction with FIG. 5A and an exemplary parameter hierarchy 610 described supra in conjunction with FIG. 6A.

Step 830 maps event nodes of the event hierarchy to at least one parameter node of the parameter hierarchy, as illustrated in FIG. 5B described supra and FIG. 6B described supra.

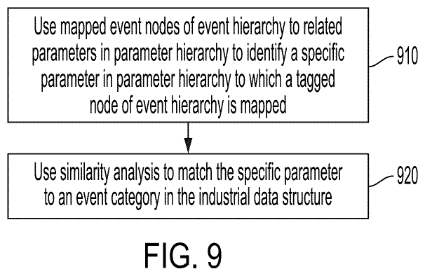

Step 840 maps tagged nodes of the event hierarchy to respective event categories within an industrial data structure, wherein each event category encompasses at least one category variable identified in the industrial data structure, as illustrated in FIG. 5D described supra and FIG. 6D described supra. Details of mapping tagged event nodes of the event hierarchy to respective event categories within an industry data structure is described infra in conjunction with FIG. 9.

Steps 850 and 860 perform different embodiments of the present invention. Step 850, step 860, or both step 850 and step 860 may be performed.

The following scenario applies to step 850. A first trigger node of the event hierarchy is a parent node to a plurality of leaf nodes of the event hierarchy. The tagging of event nodes in step 730 results in each leaf node of the plurality of leaf nodes in the event hierarchy being tagged and the first trigger node not being tagged. The mapping the tagged event nodes in step 840 results in the first trigger node being mapped to a first event category in the industrial data structure and each leaf node of the plurality of leaf nodes not being mapped to any event category in the industrial data structure.

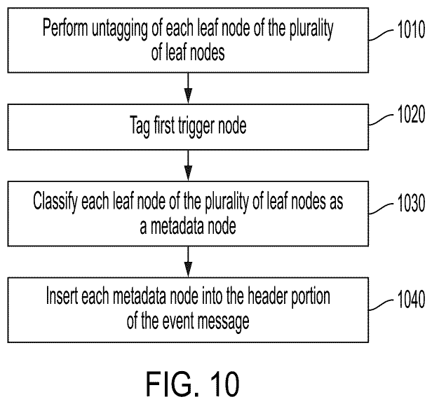

In response to the preceding scenario and after the tagged event nodes are mapped to respective event categories within an industry data structure in step 840 and before the header portion of the event message is sent in step 750, step 850 classifies selected leaf nodes of the event hierarchy as metadata nodes and inserts each metadata node into the header portion of the event message, as described infra in conjunction with FIG. 10. Step 850 is illustrated by the combination of FIGS. 6D and 6E described supra.

The following scenario applies to step 860. The mapping the event nodes to parameter nodes of parameter hierarchy in step 830 results in one trigger node of the event hierarchy being mapped to at least one parameter node identified by the parameter hierarchy, The mapping of tagged event nodes in the event hierarchy to respective event categories within an industry data structure results in the one trigger node being mapped to one event category in the industrial data structure, wherein the at least one parameter node comprises at least one parameter, wherein the one event category encompasses one or more category variables not encompassing the at least one parameter.

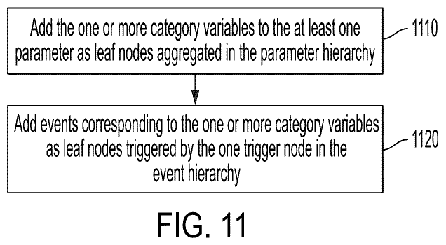

In response to the preceding scenario, step 860 adds parameter nodes to the parameter hierarchy and adds event nodes to the event hierarchy, as described infra in conjunction with FIG. 11. Step 860 is illustrated by the combination of FIGS. 6D and 6F described supra.

FIG. 9 is a flow chart of a process describing implementation of step 840 of FIG. 8 in which tagged event nodes of the event hierarchy are mapped to respective event categories within an industry data structure, in accordance with embodiments of the present invention. The flow chart of FIG. 9, which is illustrated in FIG. 5D described supra and FIG. 6D described supra, includes steps 910-920.

Step 910 uses mapped event nodes of the event hierarchy to parameters in the parameter hierarchy to identify a specific parameter in the parameter hierarchy to which a tagged node of the event hierarchy is mapped.

After the specific parameter in the parameter hierarchy is identified, step 920 uses similarity analysis to match the specific parameter to an event category in the industrial data structure.

FIG. 10 is a flow chart of a process describing implementation of step 850 of FIG. 8 in which selects leaf nodes of event hierarchy are classified as metadata nodes, in accordance with embodiments of the present invention. The flow chart of FIG. 10, which is illustrated by the combination of FIGS. 6D and 6E described supra, includes steps 1010-1040.

Step 1010 performs untagging of each leaf node of the plurality of leaf nodes.

Step 1020 tags the first trigger node.

Step 1030 classifies each leaf node of the plurality of leaf nodes as a metadata node.

Step 1040 inserts each metadata node into the header portion of the event message.

FIG. 11 is a flow chart of a process describing implementation of step 860 of FIG. 8 in which parameter nodes are added to the parameter hierarchy and event nodes are added to the event hierarchy, in accordance with embodiments of the present invention. The flow chart of FIG. 11, which is illustrated by the combination of FIGS. 6D and 6F described supra, includes steps 1110-1120.

Step 1110 adds the one or more category variables to the at least one parameter as leaf nodes aggregated in the parameter hierarchy.

Step 1120 adds events corresponding to the one or more category variables as leaf nodes triggered by the one trigger node in the event hierarchy.

FIG. 12 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 12 shows the computer system 90 as a particular configuration of hardware and software, any configuration of hardware and software, as would be known to a person of ordinary skill in the art, may be utilized for the purposes stated supra in conjunction with the particular computer system 90 of FIG. 12. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium or one or more computer readable storage media or a computer readable hardware storage device or one or more computer readable hardware storage devices, as such terms are used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 13 depicts a computing environment 100 which contains an example of an environment for the execution of at least some of the computer code involved in performing the inventive methods, in accordance with embodiments of the present invention. Such computer code includes new code for processing events in an event-driven architecture 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 13. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for processing events in an event-driven architecture, said method comprising:
performing, by one or more processors of a computer system, a dynamic scan of log data generated from multiple executions of a software program that executes events, said dynamic scan identifying a plurality of events that occurred and identifying event triggers that invoked the identified events or invoked other event triggers;
generating, by the one or more processors, an event hierarchy by organizing the identified events and identified event triggers into the event hierarchy of N levels denoted as levels 1, . . . , N wherein N is at least 2, said event hierarchy comprising event nodes and event edges, each event edge connecting two event nodes disposed at successive levels of the N levels, the event nodes of level N being leaf nodes, each leaf node comprising program code whose execution performs one event of the identified events, the event nodes of levels 1, . . . , N−1 being trigger nodes encompassing the identified event triggers and respectively triggering event nodes 2, . . . , N;
tagging, by the one or more processors, each event node satisfying criteria involving a frequency of occurrence of the events directly or indirectly invoked by each event node;
generating, by the one or more processors, an event message having a header portion and a body portion, the body portion comprising attributes of the plurality of events, the header portion comprising an identification of all tagged event nodes; and
sending, by the one or more processors, the header portion, but not the body portion, of the event message to all event subscribers who are subscribed to at least one event of the plurality of events.

2. The method of claim 1, said method further comprising:
performing, by the one or more processors, a static scan of the software program, wherein the static scan identifies parameters whose value may be changed in accordance with events, and wherein the parameters are variables in the software program.

3. The method of claim 2, said method further comprising:
generating, by the one or more processors, a parameter hierarchy by organizing the identified parameters into the parameter hierarchy of M levels denoted as levels 1, . . . , M wherein M is at least 2, said parameter hierarchy comprising parameter nodes and parameter edges, each parameter edge connecting two parameter nodes disposed at successive levels of the M levels, the parameter nodes of level M being leaf nodes, each leaf node encompassing one parameter of the identified parameters, each parameter node of level 1, . . . , M−1 being an aggregation node respectively encompassing all parameter nodes at level 2, . . . , M to which each parameter node is connected by a parameter edge.

4. The method of claim 3, said method further comprising:
mapping, by the one or more processors, the event nodes of the event hierarchy to parameter nodes of the parameter hierarchy.

5. The method of claim 4, said method further comprising:
mapping, by the one or more processors using the mapping of the event nodes of the event hierarchy to parameters in the parameter hierarchy, the tagged nodes of the event hierarchy to respective event categories within an industrial data structure, each event category encompassing at least one category variable identified in the industrial data structure.

6. The method of claim 5, wherein said mapping the tagged nodes comprises:
using mapped event nodes of the event hierarchy to parameters in the parameter hierarchy to identify a specific parameter in the parameter hierarchy to which a tagged node of the event hierarchy is mapped; and
after the specific parameter in the parameter hierarchy is identified, using similarity analysis to match the specific parameter to an event category in the industrial data structure.

7. The method of claim 5, wherein a first trigger node of the event hierarchy is a parent node to a plurality of leaf nodes of the event hierarchy, wherein said tagging results in each leaf node of the plurality of leaf nodes being tagged and the first trigger node not being tagged, wherein said mapping the tagged nodes results in the first trigger node being mapped to a first event category in the industrial data structure and each leaf node of the plurality of leaf nodes not being mapped to any event category in the industrial data structure, and wherein the method comprises after said mapping the tagged event nodes and before said sending the event message:
untagging each leaf node of the plurality of leaf nodes;
tagging the first trigger node;
classifying each leaf node of the plurality of leaf nodes as a metadata node; and
inserting each metadata node into the header portion of the event message.

8. The method of claim 5, wherein said mapping the event nodes results in one trigger node of the event hierarchy being mapped to at least one parameter node identified by the parameter hierarchy, wherein said mapping tagged nodes results in the one trigger node being mapped to one event category in the industrial data structure, wherein the at least one parameter node comprises at least one parameter, wherein the one event category encompasses one or more category variables not encompassing the at least one parameter, and wherein the method further comprises:
adding, by the one or more processors, the one or more category variables to the at least one parameter as leaf nodes aggregated in the parameter hierarchy; and
adding, by the one or more processors, events corresponding to the one or more category variables as leaf nodes triggered by the one trigger node in the event hierarchy.

9. A computer program product, comprising one or more computer readable hardware storage devices having computer readable program code stored therein, said program code containing instructions executable by one or more processors of a computer system to implement a method for processing events in an event-driven architecture, said method comprising:
performing, by the one or more processors, a dynamic scan of log data generated from multiple executions of a software program that executes events, said dynamic scan identifying a plurality of events that occurred and identifying event triggers that invoked the identified events or invoked other event triggers;
generating, by the one or more processors, an event hierarchy by organizing the identified events and identified event triggers into the event hierarchy of N levels denoted as levels 1, . . . , N wherein N is at least 2, said event hierarchy comprising event nodes and event edges, each event edge connecting two event nodes disposed at successive levels of the N levels, the event nodes of level N being leaf nodes, each leaf node comprising program code whose execution performs one event of the identified events, the event nodes of levels 1, . . . , N−1 being trigger nodes encompassing the identified event triggers and respectively triggering event nodes 2, . . . , N;
tagging, by the one or more processors, each event node satisfying criteria involving a frequency of occurrence of the events directly or indirectly invoked by each event node;
generating, by the one or more processors, an event message having a header portion and a body portion, the body portion comprising attributes of the plurality of events, the header portion comprising an identification of all tagged event nodes; and
sending, by the one or more processors, the header portion, but not the body portion, of the event message to all event subscribers who are subscribed to at least one event of the plurality of events.

10. The computer program product of claim 9, said method further comprising:
performing, by the one or more processors, a static scan of the software program, wherein the static scan identifies parameters whose value may be changed in accordance with events, and wherein the parameters are variables in the software program.

11. The computer program product of claim 10, said method further comprising:
generating, by the one or more processors, a parameter hierarchy by organizing the identified parameters into the parameter hierarchy of M levels denoted as levels 1, . . . , M wherein M is at least 2, said parameter hierarchy comprising parameter nodes and parameter edges, each parameter edge connecting two parameter nodes disposed at successive levels of the M levels, the parameter nodes of level M being leaf nodes, each leaf node encompassing one parameter of the identified parameters, each parameter node of level 1, . . . , M−1 being an aggregation node respectively encompassing all parameter nodes at level 2, . . . , M to which each parameter node is connected by a parameter edge.

12. The computer program product of claim 11, said method further comprising:
mapping, by the one or more processors, the event nodes of the event hierarchy to parameter nodes of the parameter hierarchy.

13. The computer program product of claim 12, said method further comprising:
mapping, by the one or more processors using the mapping of the event nodes of the event hierarchy to parameters in the parameter hierarchy, the tagged nodes of the event hierarchy to respective event categories within an industrial data structure, each event category encompassing at least one category variable identified in the industrial data structure.

14. The computer program product of claim 12, wherein said mapping the tagged nodes comprises:
using mapped event nodes of the event hierarchy to parameters in the parameter hierarchy to identify a specific parameter in the parameter hierarchy to which a tagged node of the event hierarchy is mapped; and
after the specific parameter in the parameter hierarchy is identified, using similarity analysis to match the specific parameter to an event category in the industrial data structure.

15. The computer program product of claim 12, wherein a first trigger node of the event hierarchy is a parent node to a plurality of leaf nodes of the event hierarchy, wherein said tagging results in each leaf node of the plurality of leaf nodes being tagged and the first trigger node not being tagged, wherein said mapping the tagged nodes results in the first trigger node being mapped to a first event category in the industrial data structure and each leaf node of the plurality of leaf nodes not being mapped to any event category in the industrial data structure, and wherein the method comprises after said mapping the tagged event nodes and before said sending the event message:
untagging each leaf node of the plurality of leaf nodes;
tagging the first trigger node;
classifying each leaf node of the plurality of leaf nodes as a metadata node; and
inserting each metadata node into the header portion of the event message.

16. The computer program product of claim 12, wherein said mapping the event nodes results in one trigger node of the event hierarchy being mapped to at least one parameter node identified by the parameter hierarchy, wherein said mapping tagged nodes results in the one trigger node being mapped to one event category in the industrial data structure, wherein the at least one parameter node comprises at least one parameter, wherein the one event category encompasses one or more category variables not encompassing the at least one parameter, and wherein the method further comprises:
adding, by the one or more processors, the one or more category variables to the at least one parameter as leaf nodes aggregated in the parameter hierarchy; and
adding, by the one or more processors, events corresponding to the one or more category variables as leaf nodes triggered by the one trigger node in the event hierarchy.

17. A computer system, comprising one or more processors, one or more memories, and one or more computer readable hardware storage devices, said one or more hardware storage devices containing program code executable by the one or more processors via the one or more memories to implement a method for processing events in an event-driven architecture, said method comprising:
performing, by the one or more processors, a dynamic scan of log data generated from multiple executions of a software program that executes events, said dynamic scan identifying a plurality of events that occurred and identifying event triggers that invoked the identified events or invoked other event triggers;
generating, by the one or more processors, an event hierarchy by organizing the identified events and identified event triggers into the event hierarchy of N levels denoted as levels 1, . . . , N wherein N is at least 2, said event hierarchy comprising event nodes and event edges, each event edge connecting two event nodes disposed at successive levels of the N levels, the event nodes of level N being leaf nodes, each leaf node comprising program code whose execution performs one event of the identified events, the event nodes of levels 1, . . . , N−1 being trigger nodes encompassing the identified event triggers and respectively triggering event nodes 2, . . . , N;
tagging, by the one or more processors, each event node satisfying criteria involving a frequency of occurrence of the events directly or indirectly invoked by each event node;
generating, by the one or more processors, an event message having a header portion and a body portion, the body portion comprising attributes of the plurality of events, the header portion comprising an identification of all tagged event nodes; and
sending, by the one or more processors, the header portion, but not the body portion, of the event message to all event subscribers who are subscribed to at least one event of the plurality of events.

18. The computer system of claim 17, said method further comprising:
performing, by the one or more processors, a static scan of the software program, wherein the static scan identifies parameters whose value may be changed in accordance with events, and wherein the parameters are variables in the software program.

19. The computer system of claim 18, said method further comprising:
generating, by the one or more processors, a parameter hierarchy by organizing the identified parameters into the parameter hierarchy of M levels denoted as levels 1, . . . , M wherein M is at least 2, said parameter hierarchy comprising parameter nodes and parameter edges, each parameter edge connecting two parameter nodes disposed at successive levels of the M levels, the parameter nodes of level M being leaf nodes, each leaf node encompassing one parameter of the identified parameters, each parameter node of level 1, . . . , M−1 being an aggregation node respectively encompassing all parameter nodes at level 2, . . . , M to which each parameter node is connected by a parameter edge.

20. The computer system of claim 19, said method further comprising:
mapping, by the one or more processors, the event nodes of the event hierarchy to parameter nodes of the parameter hierarchy.
